(19) United States
(12) Patent Application Publication
(10) Pub. No.: US 2017/0094958 A1
(43) Pub. Date: Apr. 6, 2017

(54) FISHING BAIT COVER

(71) Applicant: Skin It Enterprises, LLC, Indialantic, FL (US)

(72) Inventor: Albert John Steiginga, Indialantic, FL (US)

(73) Assignee: Skin It Enterprises, LLC, Indialantic, FL (US)

(21) Appl. No.: 14/872,467

(22) Filed: Oct. 1, 2015

(51) Int. Cl. A01K 83/06

(52) U.S. Cl. CPC A01K 83/06

(57) ABSTRACT

A bait cover for securing a hook to a fish is provided. The bait cover may include an elastic and non-porous tube. A closed end of the tube may be configured to be pierced by a hook tip. The tube may have a non-stretched length to non-stretched width ratio between 3.9 and 4.4. A wall connects the closed end of the tube to an open end of the tube. The tube may be configured to secure the hook located at least partially between the wall and an external surface of the fish located at least partially within the tube with a line end of the hook outside the tube and a medial hook portion within the tube. The tube may further be configured to conform to the contour of at least a portion of the fish and a portion of the hook located within the tube.

### FIELD OF THE INVENTION

This invention relates generally to fishing aids. More specifically, this invention relates to an elastic bait cover, and method of using same, capable of securing bait fish to a fishing hook. The bait cover is dimensioned to secure the fishing hook to the bait fish in order to improve a fisherman's chances of catching a game fish by minimizing the chance that the game fish will be able to “steal” the bait without being caught on the hook and preserving the bait fish from degradation when trolling.

### BACKGROUND

Fishing is not only a popular pastime but also a commercial industry, as well as a sport. All those that fish generally use a form of bait to lure a fish to some sort of hook. Many fishermen, especially those who do so recreationally, attach various kinds of bait fish to hooks which are in turn attached to a fishing line that is coupled to a fishing rod. A hook according to the prior art is illustrated in FIG. 10. Catching a fish with a fishing lure is essentially a two-step process: first one must attract the fish with a lure by using a good bait, and then one must actually snare the fish on a hook while the game fish is trying to eat the bait fish. There are many companies who market different fishing lures to attract fish, leaving fishermen with the dilemma of how to attach a bait fish to a hook in such a way that the bait fish will stay on the hook during casting, while trolling, and while a game fish is striking. Some bait fish are fragile, thus contributing to the difficulty of securely attaching the bait fish to a hook.

There have been various attempts to use holders of some kind to secure bait to a hook. For example, U.S. Pat. No. 4,961,280 issued to Hudson discloses a transparent member for encasing the hook and the bait and a sealing means for sealing the bait and hook in the transparent member. The Hudson patent presents several problems, however. First, the sealing member prevents fish from being able to nibble on any portion of the bait, since it is entirely encased in the transparent member. Additionally, the transparent member is fixed in size and therefore unable to retain bait by means of frictional engagement. U.S. Pat. No. 4,788,788 issued to Brockett discloses a catfish bait holder that utilizes a hollow cylinder and a cylindrical sponge to keep bait inside. The Brockett cylinder is designed for use with viscous bait, not a whole bait fish. Like the Hudson patent, the Brockett cylinder is fixed in size and is therefore unable to retain a bait fish through frictional engagement.

A need therefore existed for an elastic bait cover capable of expanding while at the same time securely retaining bait fish to a hook in order to improve a fisherman's chances of catching a fish by minimizing the chance that a fish will be able to separate the bait from the hook without being caught on the hook and retaining the integrity of the bait fish while also preventing weeds from collecting on the hook while trolling.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a bait cover for securing a hook to a fish. Embodiments of the present invention advantageously enhance the connection between the bait fish and the hook to prevent the bait fish from coming off the hook. Embodiments of the present invention also advantageously enhance the ability to catch fish by preventing the loss of bait fish.

The above benefits features and advantages according to embodiments of the present invention are provided by a hook that may have a hook tip opposing a line end and a medial hook portion connecting the line end to the hook tip. The fish has an external surface, and the bait cover has a tube. The tube may be elastic and non-porous, has an open end, a closed end configured to be pierced by the hook tip, a non-stretched length to non-stretched width ratio between 3.9 and 4.4 and a wall connecting the closed end to the open end. The tube may be configured to secure the hook located at least partially between the wall and the external surface of the fish located at least partially within the tube with the line end outside the tube and the medial hook portion within the tube. The tube is further configured to conform to the contour of a portion of the fish and a portion of the hook located within the tube.

The tube may be vulcanized. A single aperture may be located in the closed end. The single aperture may be configured to allow the hook tip and the medial hook portion to enter the tube with the line end positioned outside the tube. The hook tip may be located between the wall and the external surface of the fish.

The wall may have a first thickness proximate the open end and a second thickness proximate the closed end. The second thickness may be at least twice the first thickness. The thickness may taper. The second thickness may be less than 1/32 of an inch. There may be no reinforcement to the tube proximate the open end. The bait cover may have a trolling lure adjacent the closed end and carried by the line end. The non-stretched length to the non-stretched width ratio may be between 4.0 and 4.3. The tube may be configured to retain a ballyhoo within the wall. The bait cover according to the embodiments of the present invention may advantageously be used for securing a hook to a ballyhoo.

A method aspect of the present invention is for securing a hook to a fish. The method may include the step of obtaining a tube that may be configured to secure the hook located at least partially between the wall and the external surface of the fish located at least partially within the tube with the line end outside the tube and the medial hook portion within the tube, and further configured to conform to the contour of a portion of the fish and a portion of the hook located within the tube. The method may also include the steps of inserting a hook tip into the tube through the closed end and positioning the fish between the wall and the hook. The method may also include the step of positioning a trolling lure around the hook.

### BRIEF DESCRIPTION OF THE DRAWINGS

FIG. 1 is a perspective side view of a bait cover according to an embodiment of the present invention.

FIG. 2 is a side view of the bait cover of FIG. 1.

FIG. 3 is a top view of the bait cover of FIG. 1 in a rolled configuration.

FIG. 4 is an environmental view of the bait cover of FIG. 1 in combination with a fish and a hook.

FIG. 5 is a cross-section view taken along the 5-5 line of the bait cover of FIG. 2.

FIG. 6 is a cross-section view taken along the 6-6 line of the bait cover of FIG. 2.

FIG. 7 is a side view of the bait cover of FIG. 1 in a flat, non-stretched configuration.

FIG. 8 is an environmental view of the bait cover of FIG. 1 in combination with a fish, a hook, and a trolling lure.

FIG. 9 is a closed end perspective view of the bait cover of FIG. 1.

FIG. 10 is a side view of a prior art hook.

FIG. 11 is a flow chart of a method for securing a hook to a fish according to an embodiment of the present invention.

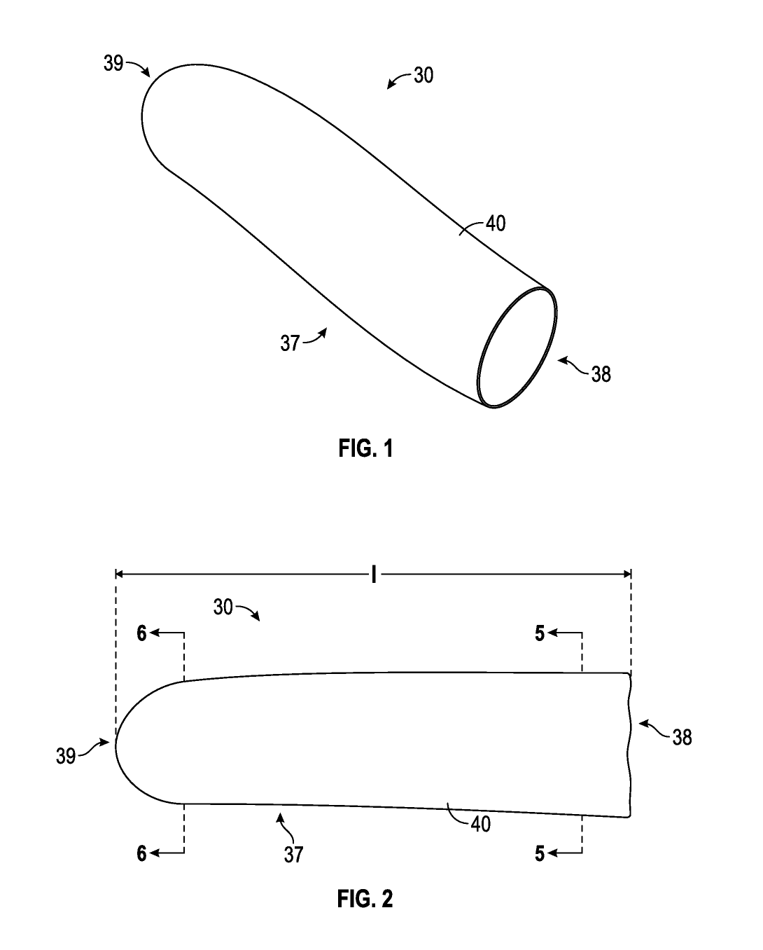

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a bait cover 30 for securing a hook 32 to a fish

The hook 32 may have a line end 33, a hook tip 34, and a medial hook portion 35. The line end 33 may oppose the hook tip 34. The line end 33 may be configured to secure to fishing line. The fishing line may have a proximate end secured to the line end 33 and a distal end secured to a fishing rod or reel. The hook tip 34 may be distal the line end 33. The hook tip 34 may be tapered, angled, sharp, or the like. The hook tip 34 may be configured to ensnare a fish 31 when consumed by the fish 31. The medial hook portion 35 may connect the line end 33 to the hook tip 34. The medial hook portion 35 may be curved.

The fish 31 may be a single bait fish. The fish 31 may be a single ballyhoo. In embodiments in which the fish 31 is a ballyhoo, the ballyhoo may be small, medium, large, select, or the like. The fish 31 may have an external surface 36. The external surface 36 may be the exterior of the fish 31.

The bait cover 30 may have a tube 37. The tube 37 may be elastic. The elastic tube 37 may have a non-stretched width w and a non-stretched length l. When external forces act on the tube 37, the tube 37 may have a stretched width w larger than the non-stretched width w. When external forces act on the tube 37, the tube 37 may have a stretched length larger than the non-stretched length l. When external forces are removed from the tube 37, the tube 37 may return to its non-stretched width w and non-stretched length l.

The tube 37 may be non-porous. This means that the tube 37 may be configured to prevent water or other fluids from passing through the wall 40 of the tube 37. The wall 40 of the tube 37 may be impervious to fluids and capable of retaining fluid within the tube 37.

The tube 37 may have an open end 38 and a closed end 39. The open end 38 may oppose the closed end 39. The open end 38 may provide access to place the fish 31 within the tube 37. The closed end 39 may prevent the fish 31 from exiting the tube 37.

The closed end 39 may be configured to be pierced by the hook tip 34. The hook tip 34 may pierce the hook tip 34 to form an aperture 41 in the closed end 39. The aperture 41 may be disposed in the closed end 39 during manufacture of the bait cover 30. The hook tip 34 and at least a portion of the medial hook portion 35 may be inserted into the tube 37 through the aperture 41. The line end 33 may be positioned outside the tube 37 when the hook tip 34 and at least a portion of the medial hook portion 35 are positioned within the tube 37. In one embodiment, the entire hook 32 may be inserted through the aperture 41 and located inside the tube 37. The presence of the aperture 41 in the closed end 39 may not render the bait cover 30 porous. Only the presence of more than one aperture 41 in the closed end 39 or the wall 40 may make the tube 37 porous.

The tube may have a non-stretched length l, as depicted in FIG. 2. The non-stretched length l may extend from the closed end 39 to the open end 38 when the tube 37 is not acted on by outside forces. The tube may be stretched to a stretched length that is longer than its non-stretched length l. The tube may return to its non-stretched length l when it is not being acted on by outside forces.

The tube 37 may have a non-stretched width w, as depicted in FIG. 7. The non-stretched width w may extend from a first side of the tube 37 to a second side of the tube 37 when the tube 37 is laid flat, as shown in FIG. 7. The tube may be stretched to a stretched width that is wider than its non-stretched width w. The tube 37 may return to its non-stretched width w when it is not being acted on by outside forces.

The tube 37 may be configured to retain a single small or medium ballyhoo within the walls 40 of the tube 37. In one embodiment, the tube 37 may have a non-stretched length l ranging from 4.2 to 4.8 inches. The non-stretched length l may range from 4.4 to 4.6 inches. The non-stretched length l may be 4.5 inches. The tube 37 may have a non-stretched width w ranging from 0.8 to 1.4 inches. The non-stretched width w may range from 0.9 to 1.3 inches. The non-stretched width w may be 1.1 inches. The tube 37 may have a non-stretched length to non-stretched width ratio between 3.9 and 4.4. The tube 37 may have a non-stretch length to non-stretched width ratio between 4.0 and 4.2. The tube 37 may have a non-stretched length to non-stretched width ratio of 4.1.

The tube 37 may be configured to retain a single select ballyhoo within the walls 40 of the tube 37. In one embodiment, the tube 37 may have a non-stretched length l ranging from 5.0 to 5.5 inches. The non-stretched length l may range from 5.15 to 5.35 inches. The non-stretched length l may be 5.25 inches. The tube 37 may have a non-stretched width w ranging from 1.0 to 1.5 inches. The non-stretched width w may range from 1.15 to 1.35 inches. The non-stretched width w may be 1.25 inches. The tube 37 may have a non-stretched length to non-stretched width ratio between 4.0 and 4.4. The tube 37 may have a non-stretched length to non-stretched width ratio between 4.1 and 4.3. The tube 37 may have a non-stretch length to non-stretched width ratio between 4.0 and 4.3. The tube 37 may have a non-stretched length to non-stretched width ratio of 4.2.

The tube 37 may have a wall 40 connecting the closed end 39 to the open end 38. The wall 40 may be formed from latex. A first interior surface of the wall 40 may oppose a second interior surface of the wall 40 within the tube 37. An exterior surface of the wall 40 may form at least a portion of the exterior surface of the tube 37. The wall 40, the open end 38, and the closed end 39 may be a monolithic unit. The tube 37, or any portion of the tube 37, may be made from latex. The monolithic unit may be formed from latex. The tube 37, or any portion of the tube 37, may be vulcanized.

The tube 37 may be configured to secure and retain a fish 31 within the tube 37. The interior surface of the walls 40 may be configured to conform to at least a portion of a fish 31 located within the tube 37. The compression of the walls 40 of the tube 37 may retain the fish 31 within the tube 37.

The tube 37 may be configured to secure and retain at least a portion of the hook 37 between an interior surface of the wall 40 and an external surface of the fish 31 retained within the tube 37. The hook tip 34 may be retained between an interior surface of the wall 40 and an external surface of the fish 31. Such a placement of the hook tip 34 may prevent the hook 32 from collected or snagging weeds or other debris that may be present in the aqueous environment in which the bait cover 30 may be utilized. The entire hook 32 may be retained between the external surface of the fish 31 and an interior surface of the wall 40. The medial hook portion 35 may be retained between the external surface of the fish 31 and an interior surface of the wall 40. The line end 33 of the hook 32 may remain outside the tube 37 while at least a portion of the medial hook portion 35 is retained within the tube 37. The walls 40 may be configured to conform to the contour of a portion of the hook 32 located between the fish 31 and an interior surface of the wall 40.

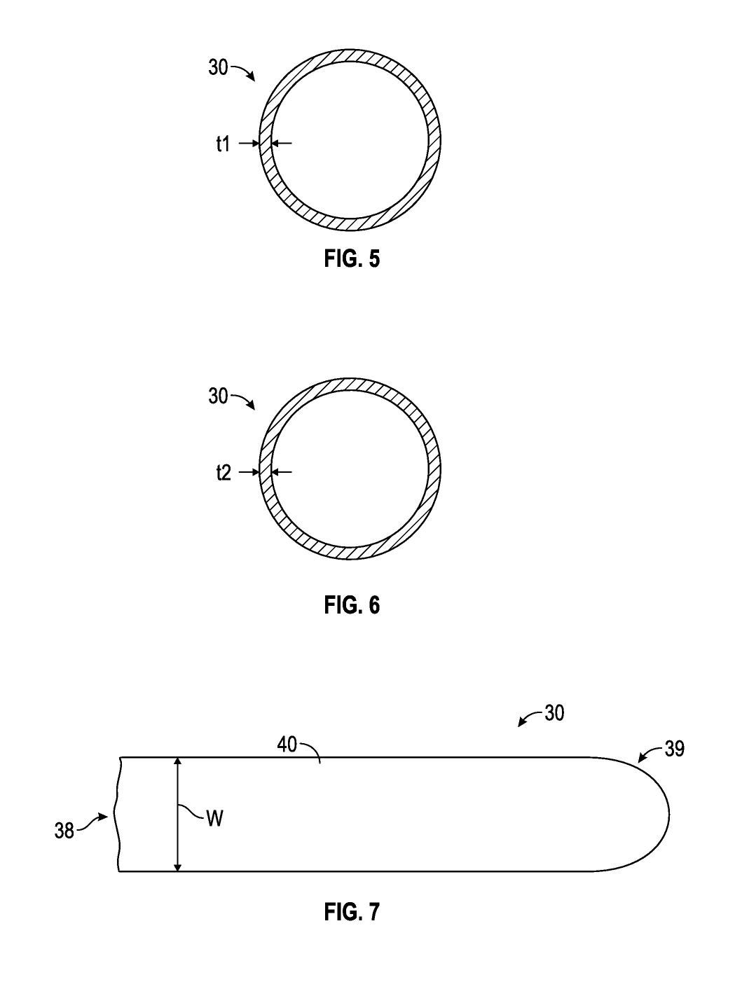

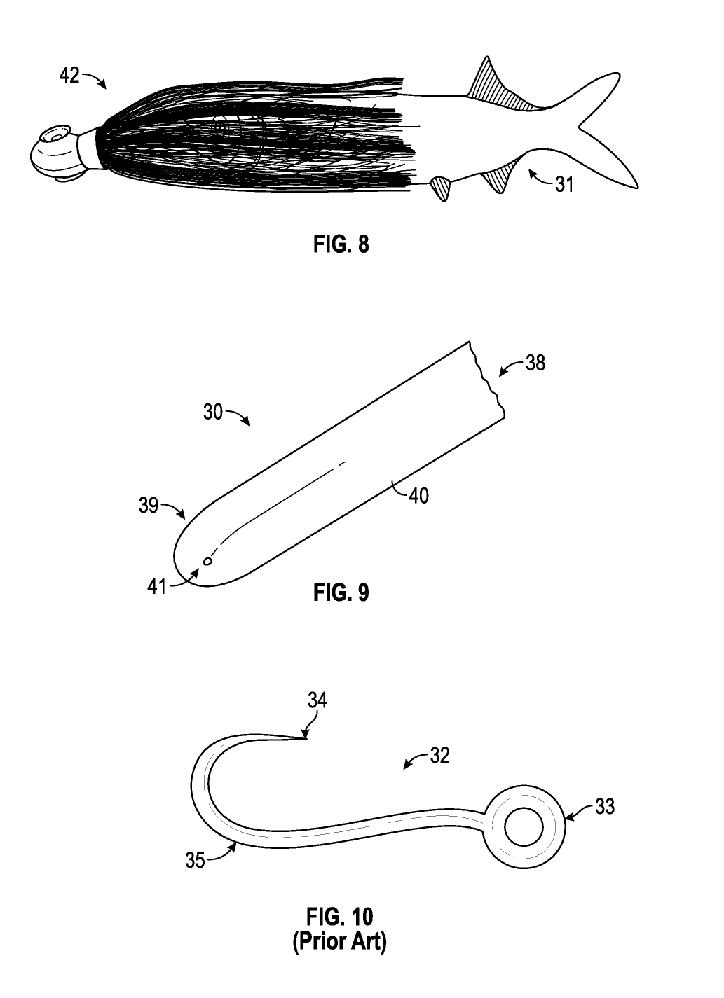

As shown in FIG. 5, the wall 40 may have a first thickness t1 proximate the open end 38. The first thickness t1 may range from 0.015 inches to 0.006 inches. The first thickness t1 may range from 0.009 inches to 0.007 inches. The first thickness t1 may be 1/128 inches.

As shown in FIG. 6, the wall 40 may have a second thickness t2 proximate the closed end 39. The second thickness t2 may range from 0.01 inches to 0.031 inches. The second thickness t2 may range from 0.01 inches to 0.02 inches. The second thickness may be less than 1/32 inches. The second thickness t2 may be 1/64 inches.

The second thickness t2 may be at least twice the first thickness t1. The thickness of the wall 40 may taper from a second thickness t2 to a first thickness t1. The thickness may taper when it gradually decreases from a second thickness t2 to a first thickness t1.

The thickness of the wall proximate the open end 38 may be essentially uniform and equal or similar to the first thickness t1. There may be no reinforcement to the tube 37 proximate the open end 38.

A fishing lure may be located adjacent the closed end 39. The fishing lure may be a trolling lure 42. The trolling lure 42 may have a skirt surrounding the closed end 39 of the tube 37. The skirt may extend away from the closed end 39 of the tube 37 and down at least a portion of the length of the fish 31 when the fish 31 is retained within the tube 37. The trolling lure 42 may be carried by the line end 33 of the hook 32. The trolling lure 42 may be carried by a portion of fishing line that may be secured to or adjacent the line end 33 of the hook.

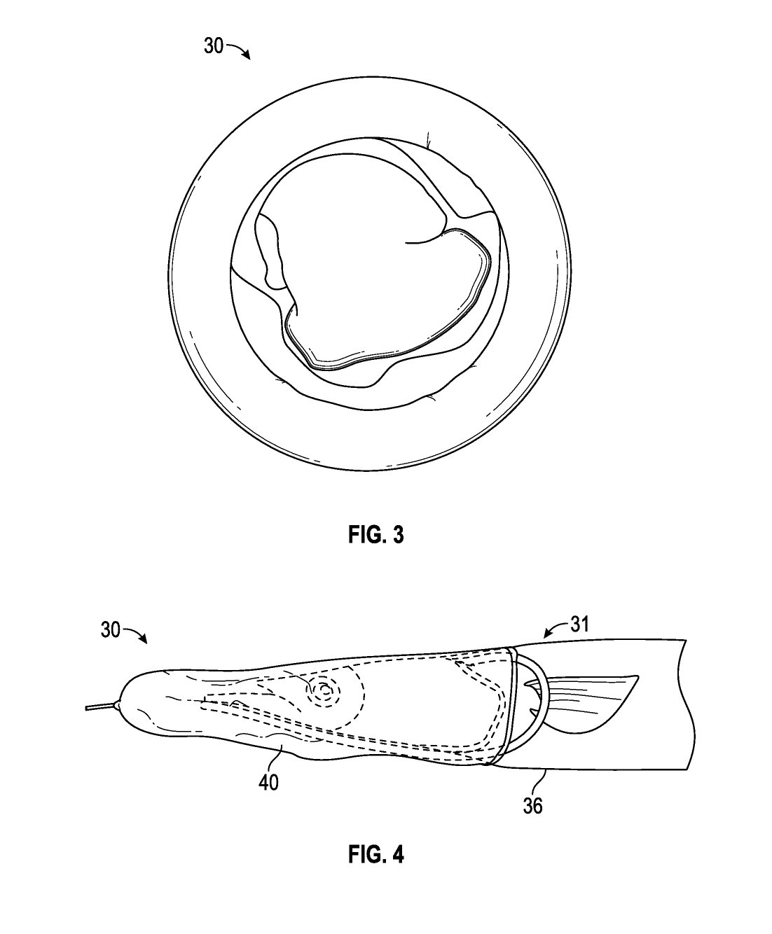

The bait cover 30 may be stored in a rolled configuration as depicted in FIG. 3. When in the rolled configuration, the bait cover may be placed over the head of the fish 31 and the walls 40 may be unrolled down the length of the fish 31. When in the rolled configuration, a hook tip 34 may pierce the closed end 39 to form an aperture 41. At least a portion of the hook 32 may be placed through the aperture 41 and extend to an inner surface of the bait cover 30. A portion of the fish 31 may be located proximate the portion of the hook 32 located proximate the inner surface of the bait cover 30. The bait cover 30 walls 40 may be unrolled down the length of the fish 31 securing at least a portion of the fish 31 and at least a portion of the hook 31 within the tube 37. The bait cover 30 may be placed over the hook tip 34.

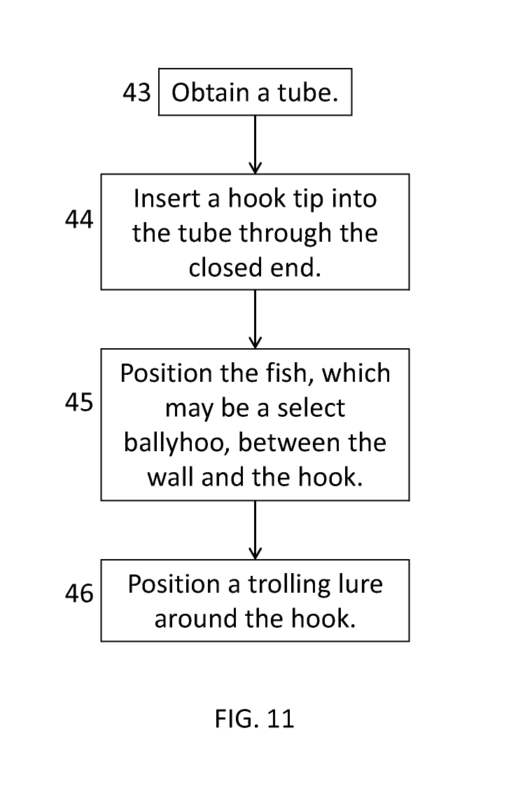

According to an inventive method depicted in FIG. 11, the hook 32 may be secured to the fish 31 using a tube. To secure the hook 32 to the fish 31, a user must obtain a tube 37 in accordance with an embodiment of the present invention (43). In one embodiment, the tube 37 may be elastic and non-porous, have an open end 38, a closed end 39 configured to be pierced by the hook tip 34, a non-stretched length l to non-stretched width w ratio between 3.9 and 4.4, and a wall 40 connecting the closed end 39 to the open end 38. The tube 37 may be configured to secure the hook 32 located at least partially between the wall 40 and the external surface of the fish 31 located at least partially within the tube 37 with the line end 33 outside the tube 37 and the medial hook portion 35 within the tube 37 walls 40. The tube 37 may be configured to conform to the contour of a portion of the fish 31 and a portion of the hook 32 located within the tube 37. The user may insert the hook tip 34 into the tube 37 through the closed end 39 (44). The user may position the fish 31, which may be a ballyhoo, and more specifically, a select ballyhoo, between the wall 40 and the hook 32 (45). This may be done by rolling the walls 40 down at least a portion of the length of the fish 31. A trolling lure 42 may be positioned around the hook 32 (46). The trolling lure 42 may be carried by the hook 32.

Fishing attractants may be applied to the bait cover 30. The fishing attractants may be fish oil, gel, or other substances designed to attract fish. Indicia may be added to the bait cover 30. The indicia may be ornamentation adapted to make the bait cover appear similar to a bait fish. The ornamentation may include, but is not limited to, eyes, fins, scales, colors, patterns, or the like. The ornamentation may include indicia, including, but not limited, to logos. Logos may be applied to the bait cover to allow the bait cover to be used as a promotional item for businesses.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A bait cover for securing a hook, having a hook tip opposing a line end and a medial hook portion connecting the line end to the hook tip, to a fish, having an external surface, comprising:
a tube, which is elastic and non-porous, having an open end, a closed end configured to be pierced by the hook tip, a non-stretched length to non-stretched width ratio between 3.9 and 4.4 and a wall connecting the closed end to the open end, wherein the tube is configured to secure the hook located at least partially between the wall and the external surface of the fish located at least partially within the tube with the line end outside the tube and the medial hook portion within the tube, and further configured to conform to the contour of a portion of the fish and a portion of the hook located within the tube.

2. The bait cover according to claim 1 wherein the tube is vulcanized.

3. The bait cover according to claim 1 wherein a single aperture is located in the closed end, the single aperture being configured to allow the hook tip and the medial hook portion to enter the tube with the line end positioned outside the tube.

4. The bait cover according to claim 1 wherein the hook tip is located between the wall and the external surface of the fish.

5. The bait cover according to claim 1 wherein the wall has a first thickness proximate the open end and a second thickness proximate the closed end and wherein the second thickness is at least twice the first thickness.

6. The bait cover according to claim 5 wherein the thickness tapers.

7. The bait cover according to claim 1 wherein there is no reinforcement to the tube proximate the open end.

8. The bait cover according to claim 1 further comprising a trolling lure adjacent the closed end and carried by the line end.

9. The bait cover according to claim 5 wherein the second thickness is less than 1/32 of an inch.

10. The bait cover according to claim 1 wherein the non-stretched length to the non-stretched width ratio is between 4.0 and 4.3.

11. The bait cover according to claim 1 wherein the tube is configured to retain a ballyhoo within the wall.

12. A bait cover for securing a hook, having a hook tip opposing a line end and a medial hook portion connecting the line end to the hook tip, to a ballyhoo, having an external surface, comprising:
a tube, which is vulcanized, elastic, and non-porous, having a thickness that tapers, an open end, a closed end with a single aperture configured to allow the hook tip and the medial hook portion to enter the tube while the line end is positioned outside the tube, a non-stretched length to non-stretched width ratio between 4.0 and 4.3 and a wall connecting the closed end to the open end, wherein the tube is configured to secure the hook located at least partially between the wall and the external surface of the ballyhoo located at least partially within the tube with the line end outside the tube and the medial hook portion within the tube, and further configured to conform to the contour of a portion of the ballyhoo and a portion of the hook located within the tube.

13. The bait cover according to claim 12 wherein the hook tip is located between the wall and the external surface of the fish.

14. The bait cover according to claim 12 wherein the wall has a first thickness proximate the open end and a second thickness proximate the closed end and wherein the second thickness is at least twice the first thickness.

15. The bait cover according to claim 12 wherein there is no reinforcement to the tube proximate the open end.

16. The bait cover according to claim 14 wherein the second thickness is less than 1/32 of an inch.

17. A method for securing a hook, having a hook tip opposing a line end and a medial hook portion connecting the line end to the hook tip, to a fish, having an external surface comprising the steps of:
obtaining a tube, which is elastic and non-porous, has an open end, a closed end configured to be pierced by the hook tip, a non-stretched length to non-stretched width ratio between 3.9 and 4.4 and a wall connecting the closed end to the open end, wherein the tube is configured to secure the hook located at least partially between the wall and the external surface of the fish located at least partially within the tube with the line end outside the tube and the medial hook portion within the tube, and further configured to conform to the contour of a portion of the fish and a portion of the hook located within the tube;
inserting a hook tip into the tube through the closed end;
positioning the fish between the wall and the hook.

18. The method according to claim 17 wherein the fish is a ballyhoo.

19. The method according to claim 17 wherein the fish is a select ballyhoo.

20. The method according to claim 17 further comprising the step of positioning a trolling lure around the hook.
